(19) United States
(12) Patent Application Publication
(10) Pub. No.: US 2007/0003307 A1
(43) Pub. Date: Jan. 4, 2007

(54) Image selecting method and apparatus

(75) Inventor: Naveen Maheshwari, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/472,353

(22) Filed: Jun. 22, 2006

(30) Foreign Application Priority Data
Jun. 29, 2005 (KR) 2005-56937

(51) Int. Cl. G06F 9/00; G06F 3/00

(52) U.S. Cl. 399/81; 715/769; 715/770; 715/810

(57) ABSTRACT

An image selecting method and apparatus are provided to enable a user to conveniently select an image for use as a watermark. The image selecting method includes: checking whether an image of an image file dragged from a first operating window to a second operating window can be displayed on the second operating window; dropping the dragged image file to the second operating window if the image can be displayed on the second operating window; acquiring file information of the dropped image file; and fetching image information of the image file using the acquired file information. The first operating window displays the image file, the second operating window displays a driver which instructs to form the image of the image file, and the file information includes feature information of the image file. Accordingly, a user can easily select an image file having an image to be fetched to the second operating window, without troublesome operation of a key of the second operating window.

### CROSS-REFERENCE TO RELATED PATENT APPLICATIONS

This application claims all benefits accruing under 35 U.S.C. §119 from Korean Application No. 2005-56937, filed Jun. 29, 2005, in the Korean Intellectual Property Office, the disclosure of which is incorporated by reference herein.

### BACKGROUND OF THE INVENTION

1. Field of the Invention

The present invention relates to an image forming apparatus, and more particularly, to an image selecting method and an image forming apparatus which drags and drops an image file selected from a plurality of image files displayed on a first operating window to a second operating window and displays an image of the selected image file on the second operating window.

2. Related Art

An image forming apparatus, such as a printer, a copier, a facsimile machine and a multi-functional product, can insert a desired image into print data to be printed as a watermark and print an image of print data and the image. At this time, an image forming apparatus, such as a printer, operates according to an instruction of a host device connected to the printer, and the host device provides a display interface of a printer driver for driving the printer.

In this case, the display interface displays setting information of the printer driver and displays the image to be printed. A user who wants to insert the watermark to the print data must select an image file having an image which will be used as the watermark from the image files stored in the host device or the printer.

In a conventional image selecting method, the user must previously know a storage location of the image file having the image which will be used as the watermark. When the user does not know the location, the user must check all the image files stored in the host device or the printer so to find the image file. As a result, such a requirement can be very inconvenience to the user who selects the image.

Moreover, in the conventional image selecting method, since the user operates a key provided by the host device, and manually inputs a storing path which represents a storage location even though the user accurately know the storage location, such requirements can also cause inconvenience to the user.

### SUMMARY OF THE INVENTION

Several aspects and example embodiments of the present invention provide an image selecting method, an image forming apparatus and a computer readable medium having embodied thereon at least a computer program which drags and drops an image file selected from a plurality of image files displayed on a first operating window to a second operating window and displays an image of the selected image file on the second operating window.

Additional aspects and/or advantages of the invention will be set forth in part in the description which follows and, in part, will be obvious from the description, or may be learned by practice of the invention.

According to an aspect of the present invention, there is provided an image selecting method including: checking whether an image of an image file dragged from a first operating window to a second operating window can be displayed on the second operating window; dropping the dragged image file to the second operating window if the image can be displayed on the second operating window; acquiring file information of the dropped image file; and fetching image information of the image file using the acquired file information. The first operating window can display the image file, the second operating window is an operating window of a driver of an image forming apparatus, and the file information is information on a storage location of the image file.

In an example embodiment of the present invention, the method may further include checking whether the number of the dragged image files is plural; and progressing to the acquiring of the file information if the number of the dragged image files is singular.

In another example embodiment of the present invention, the method may further include checking whether the number of the dragged image files is plural; and progressing to the checking whether the image can be displayed on the second operating window if the number of the dragged image files is singular.

In another example embodiment of the present invention, the method may further include displaying the fetched image information. The method may further include notifying that the image information can not be fetched if the image can not be displayed on the second operating window. The method may further include notifying that only one image file can be dragged if the number of the dragged image files is plural.

According to another aspect of the present invention, there is provided an image selecting apparatus including: a checking unit which checks whether an image of an image file dragged from a first operating window to a second operating window can be displayed on the second operating window; a dropping determining unit which drops the dragged image file to the second operating window in response to the checked result of the checking unit; a file information acquiring unit which acquires file information of the dropped image file; and an image information fetching unit which fetches image information of the image file using the acquired file information, wherein the first operating window can displays the image file, the second operating window is an operating window of a driver of an image forming apparatus, and the file information is information on a storage location of the image file.

In an example embodiment of the present invention, the apparatus may further include a user interface unit which provides an interface including the first operating window and the second operating window which displays the fetched image information.

In an example embodiment of the present invention, the apparatus may further include an image information changing unit which changes the fetched image information according to a user's instruction. The image information changing unit may change a size or a location of the fetched image displayed on the second operating window according to the instruction, and the fetched image may be an image that the fetched image information represents.

In another example embodiment of the present invention, the apparatus may further include a user interface unit which provides an interface including the second operating window for displaying the changed image information.

In an example embodiment of the present invention, the checking unit may check whether the number of the dragged image files is plural. A user interface unit may also be provided to notify that only one image file can be dragged, in response to the result of checking whether the number of the dragged image files is plural.

In another example embodiment of the present invention, the drop determining unit may drop the dragged image file to the second operating window, in response of the result of checking whether the image can be displayed on the second operating window and the result of checking whether the number of the dragged image files is plural.

According to another aspect of the present invention, there is provided a computer-readable medium having embodied thereon a computer program for an image selecting method including: checking whether an image of an image file dragged from a first operating window to a second operating window can be displayed on the second operating window; dropping the dragged image file to the second operating window if the image can be displayed on the second operating window; acquiring file information of the dropped image file; and fetching image information of the image file using the acquired file information, wherein the first operating window can display the image file, the second operating window is an operating window of a driver of an image forming apparatus, and the file information is information on a storage location of the image file.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of an image selecting apparatus according to an embodiment of the present invention;

FIG. 2 is a reference diagram illustrating an image selecting apparatus according to an embodiment of the present invention; and

FIG. 3 is a flowchart of an image selecting method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

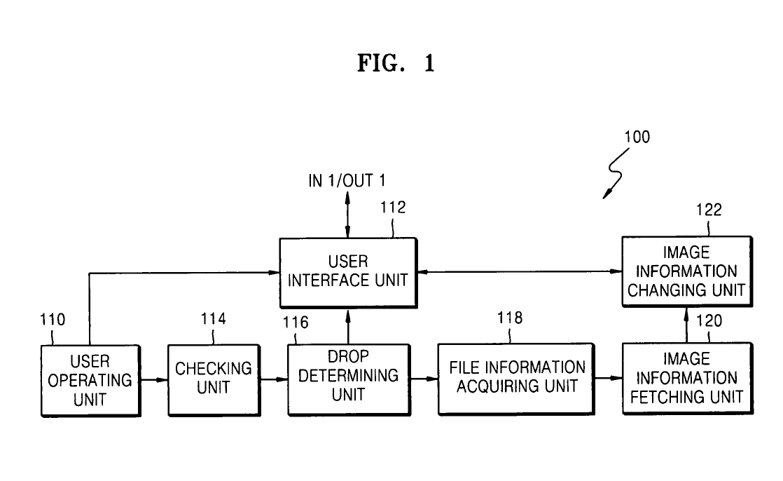

FIG. 1 is a block diagram of an image selecting apparatus according to an embodiment of the present invention. As shown in FIG. 1, the image selecting apparatus 100 includes a user operating unit 110, a user interface unit 112, a checking unit 114, a drop determining unit 116, a file information acquiring unit 118, an image information fetching unit 120, and an image information changing unit 122.

A driver for recognizing an image forming apparatus, such as a printer, must be provided to, or installed at a host device connected to the image forming apparatus so that the image forming apparatus forms an image of print data, that is, prints the print data. In addition, all the user operating unit 110, the user interface unit 112, the checking unit 114, the drop determining unit 116, the file information acquiring unit 118, the image information fetching unit 120, and the image information changing unit 122 are provided, but are not limited, to the host device. The host device can be, but not limited to, a computer system, such as a desktop computer, a laptop computer or a workstation connected to an image forming apparatus.

The host device can display setting information of the driver installed therein. In addition, the host device can previously display the image which will be formed by the image forming apparatus, such as a printer, before the image forming apparatus forms the image so that a user can see the image.

The user can instruct the image forming apparatus to insert a predetermined watermark into the print data received from the host device through the driver provided in the host device and to print the print data with the watermark.

Here, the watermark represents a mark for preventing illegal copy of the print data, and can be inserted into the print data without damaging the print data and printed together with the print data by the image forming apparatus. The watermark may be a text, an image, or a combination thereof. In an example embodiment of the present invention, the watermark is an image, and the watermark on a print matter may be examined or may not be examined with users' eyes.

The user can select an image file having the image which is used as the watermark from the image files stored in the host device or the image forming apparatus. However, the user may select the watermark for other use. That is, the watermark is suggested for convenience of explanation, but the present invention is not limited thereto.

As mentioned above, in the conventional image selecting method, the user searches all the stored image files on a second operating window, selects an image file therefrom, and accurately inputs a storage location of the image file to the host device to display the image of the selected image file on a second operating window.

Here, a first operating window can display an image file provided in the host device or the image forming apparatus. At this time, it is preferable that the image file is stored in the host device or the image forming apparatus. However, such an image file may be stored elsewhere, such as an external storage device that is inserted directly into either the host device or the image forming apparatus, or a remote server that is connected to either the host device or the image forming apparatus, via a network, such as the Internet. The first operating window may display only one image file or a plurality of the image files. Furthermore, the second operating window is an operating window of the driver of the image forming apparatus.

As the result, in the conventional image selecting method, the user must perform a troublesome operation on the second operating window to select the image. However, in an example embodiment of the present invention, the user selects an image file from the image files displayed on the first operating window and drags the image file from the first operating window to the second operating window to display an image of the selected image file on the second operating window.

Hereinafter, an image selecting procedure according to an example embodiment of the present invention will be described while describing each of the aforementioned units, as shown in FIG. 1, herein below.

The user operating unit 110 is realized by a data input device provided in the host device. At this time, the data input device represents a device for inputting data to the host device and may include a keyboard having a plurality of keys, a mouse, and a touch screen. Specifically, the user operating unit 110 may be realized by a device having a drag-and-drop function. In the present embodiment, for example, the mouse is used.

When the user operating unit 110 is realized by the mouse, the user operates the mouse, selects an image file from the image files displayed on the first operating window, and drags and drops the selected image file to the second operating window.

The user interface unit 112 displays the first operating window and the second operating window. A portion OUT1 is a display interface, and includes the first operating window and the second operating window.

The user can select a predetermined number of the image files from the image files displayed on the first operating window by the user interface unit 112. At this time, the user may select a plurality of the image files or simply a single image file. However, it is preferable that the user selects and drags only one image file.

The checking unit 114 checks whether the image of the image file dragged from the first operating window to the second operating window can be displayed on the second operating window. If a form of the image file can be supported by the driver, the image of the dragged image file can be displayed on the second operating window; however, if the form of the image file can not be supported by the driver, the image of the dragged image file can not be displayed on the second operating window. Here, the form of the image file can be distinguished by an extension of the image file. Furthermore, the checking unit 114 can check whether the number of the image files dragged from the first operating window to the second operating window is plural.

The drop determining unit 116 drops the dragged image file to the second operating window in response to the checked result of the checking unit 114. More particularly, the drop determining unit 116 drops the dragged image file to the second operating window, when the checking unit 114 checks that the image file can be dropped. Likewise, the drop determining unit 116 does not drop the dragged image file to the second operating window, when the checking unit 114 checks that the image file can not be dropped.

Here, the case where the checking unit 114 checks that the image file can be dropped, the number of the image files dragged from the first operating window to the second operating window is singular and the image of the image file dragged from the first operating window to the second operating window can be displayed on the second operating window.

Also, the case where the checking unit 114 checks that the image file can not be dropped, the number of the image files dragged from the first operating window to the second operating window is plural and the image of the image file dragged from the first operating window to the second operating window can not be displayed on the second operating window.

When the drop determining unit 116 can not drop the dragged image file to the second operating window, the user interface 112 notifies that the dragged image file can not be dropped. In this case, the portion OUT1 outputs a content which is notified by the user interface unit 112, such as, for example, “The dragged image file can not be dropped”.

Here, the content “The dragged image file can not be dropped” indicates that image information of the dragged image file can not be fetched and the image can not be selected by the embodiment of the present invention.

The file information acquiring unit 118 acquires file information of the dropped image file. The file information acquiring unit 118, the image information fetching unit 120, and the image information changing unit 122 operate when the drop determining unit 116 drops the dragged image file to the second operating window.

Here, the file information of the file is feature information of the file. For example, the file information of the image file displayed on the first operating window represents any information including feature information of the image file. Similarly, the file information of the dropped image file represents any information including feature information of the dropped image file

At this time, the image file displayed on the first operating window may be stored in the host device or the image forming apparatus. Moreover, the feature information is information on a storage location of the image file. That is, the feature information represents a storage path of the image file.

Since all the image files have their own file information, the dragged and dropped image file also has its own file information. Here, the dragged and dropped image file is equal to the dropped image file. The drag operation necessarily precedes the drop operation. As the result, the file information acquiring unit 118 analyzes the dragged and dropped image file and acquires the file information of the dragged and dropped image file.

The image information fetching unit 120 fetches the image information of the dragged and dropped image file using the file information acquired by the file information acquiring unit 118. That is, the image information fetching unit 120 fetches the image information of the image file stored in the location represented by the acquired file information. Here, the image information of the image file is information which describes an image representing the content of the image file.

The image (hereinafter, referred to as “fetched image”) of the image information fetched by the image information fetching unit 120 can be displayed by the user interface unit 112. More particularly, the fetched image can be displayed on the second operating window.

If the fetched image is printed as the watermark together with the print data when the image forming apparatus prints the print data, the second operating window displayed by the user interface unit 112 can previously display the print data and the fetched image before the image forming apparatus prints the print data and the fetched image.

If the user wants to change attribute of the fetched image, the image information changing unit 122 changes the fetched image information according to user's instruction input through the user interface unit 112. A portion IN1 represents the user's instruction.

For example, the image information changing unit 122 can change a size or a location of the fetched image displayed on the second operating window. When the image information is changed, the image forming apparatus prints the image of the changed image information.

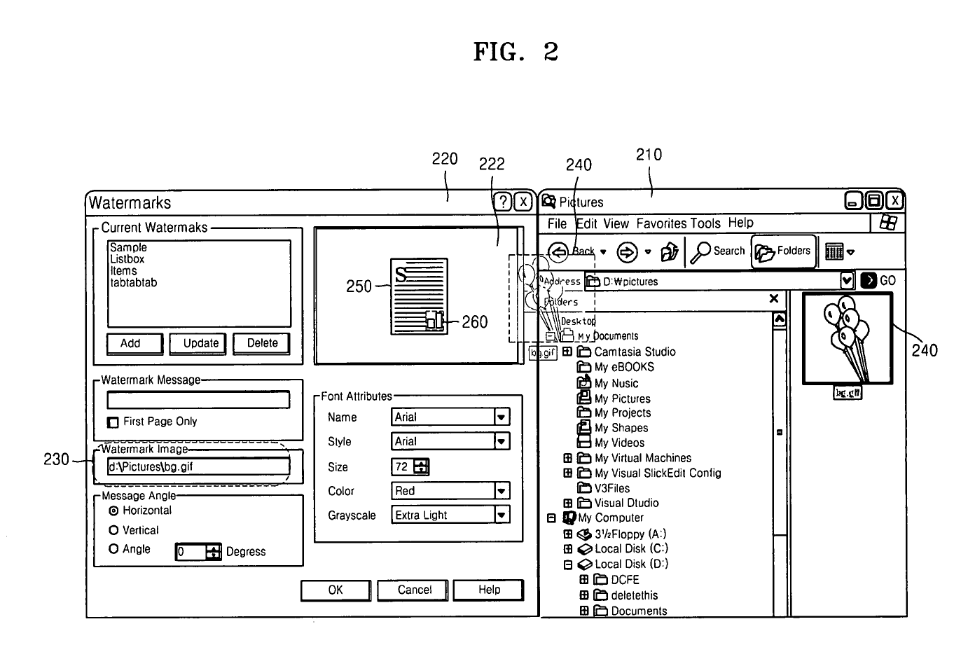

FIG. 2 is a reference diagram illustrating operations of an image selecting apparatus according to an example embodiment of the present invention. Reference numerals 210 and 220 denote the first operating window and the second operating window, respectively. More particularly, in FIG. 2, the second operating window 220 is derived from an operating window of the driver of the image forming apparatus and used for selecting an image to be used as the watermark.

As shown in FIG. 2, various setting information of the driver of the image forming apparatus is displayed on the second operating window 220. Also, the second operating window 220 previously displays the image which will be formed by the image forming apparatus. The displayed image may be displayed in a region 222 (hereinafter, referred to as “preview window”) provided in the second operating window 220.

The preview window 222 displays the print data 250 which is provided from the host device to the image forming apparatus as well as the fetched image 260 inserted into the print data 250.

The user can search the image file stored in the host device or the image forming apparatus on the first operating window 210 to select the fetched image which will be used as the watermark. In an example embodiment shown in FIG. 2, the image file is stored in the host device, such as a desktop computer; however, such an image file can be stored in an internal or external storage device, or a remote server that is connected to either the host device or the image forming apparatus, via a network, such as the Internet.

For purposes of simplicity, it is assumed that the user wants the image of the image file “bg.gif” stored in a folder “Pictures” of a “D” drive of a hard disk drive (HDD) as the watermark.

When a plurality of the image files are stored in the “D” drive, an image file 240 which is selected by the user is the image file “bg.gif” and has a storage path “D:/Pictures/bg.gif”. That is, the file information of the image file to be selected includes the location information “D:/Pictures/bg.gif”.

If the user selects only the image file ubg.gif” from the plurality of the image files stored in the “D” drive and the driver of the image forming apparatus supports the extension “gif”, the checking unit 114 instructs to operate the drop determining unit 116 so that the image can be selected, when the user drags the selected image file “bg.gif” from the first operating window 210 to the second operating window 220.

In this case, the file information acquiring unit 118 can analyze the dragged and dropped image file “bg. gif” and acquire the file information D:/Pictures/bg.gif of the image file “bg.gif”. The image information fetching unit 120 fetches the image information of the image file “bg.gif” using the acquired file information, and the second operating window 220 displays the fetched image 260 on a predetermined region 260 of the preview window 222.

In the conventional image selecting method, if a region of the second operating windows 220 for inputting the file information of the image file 240 is a file information input region 230, the file information of the image file to be selected must be input to the file information input region 230 to display the image on the second operating window 220. However, in an example embodiment of the present invention, the user drags the selected image file 240 from the first operating window 210 to the second operating window 220 to display the image on the second operating window 220.

Accordingly, according to the embodiment of the present invention, the user may not know the file information of the image file to be selected when the user displays the image on the second operating window 220, in contrast to the conventional image selecting method.

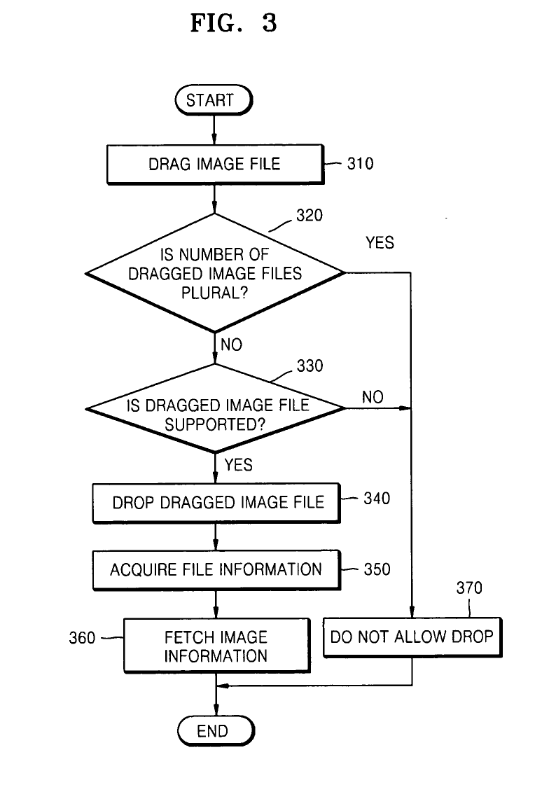

FIG. 3 is a flowchart of an image selecting method according to an embodiment of the present invention. The image selecting method includes operations (operations 310 through 330) of determining whether the dragged image file can be dropped to the second operating window, operations (operations 340 through 360) of dropping the image file when the image file can be dropped to automatically select the image on the second operating window, and operation (operation 370) of notifying that the image can not be selected if the image file can not be dropped.

The user selects a predetermined number of the image files from the image files displayed on the first operating window 210, as shown in FIG. 2, and drags the selected image file to the second operating window 220, as shown in FIG. 2, at operation 310. The checking unit 114 checks whether the number of the dragged image files is plural at operation 320.

If the number of the dragged image files is singular, the checking unit 114 checks whether the image of the dragged image file can be displayed on the second operating window 220, at operation 330, that is, if the dragged image file is supported by the driver of an image forming apparatus. If the image of the dragged image file can be displayed on the second operating window 220, the drop determining unit 116 drops the dragged image file to the second operating window 220 at operation 340.

The file information acquiring unit 118 acquires the file information of the dropped image file at operation 350, and the image information fetching unit 120 fetches the image information of the dropped image file using the acquired file information at operation 360.

If the number of the dragged image files is plural, the drop determining unit 116 determines that the dragged image files can not be dropped to the second operating window 220, and the user interface unit 112 notifies the user that the image can not be selected at operation 370.

Various components of the image selecting apparatus 100, as shown in FIG. 1, such as checking unit 114, the drop determining unit 116, the file information acquiring unit 118, the image information fetching unit 120 and the image information changing unit 122 can be integrated into a single control unit 170, or alternatively, can be implemented in software or hardware, such as, for example, an application specific integrated circuit (ASIC). As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

In addition, the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As mentioned above, in the image selecting method and apparatus according to the embodiment of the present invention, since the image file selected from the plurality of the image files displayed on the first operating window is dragged and dropped to the second operating window to display the image of the selected image file on the second operating window, the user need not know the storage location of the selected image file so as to display the image of the selected image file on the second operating window. Also, although the user knows the storage location of the selected image file, the user need not operate the key to input the storage path and thus can easily select the image file having the image which will be displayed on the second operating window without the operation of the key.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. An image selecting method comprising:
checking whether an image of an image file dragged from a first operating window to a second operating window can be displayed on the second operating window;
dropping the dragged image file to the second operating window, if the image can be displayed on the second operating window;
acquiring file information of the dropped image file; and
fetching image information of the image file using the acquired file information.

2. The method according to claim 1, wherein the first operating window can display the image file, the second operating window is an operating window of a driver of an image forming apparatus, and the file information is information on a storage location of the image file.

3. The method according to claim 1, further comprising:
checking whether the number of the dragged image files is plural; and
progressing to acquiring of the file information if the number of the dragged image files is singular.

4. The method according to claim 1, further comprising:
checking whether the number of the dragged image files is plural; and
progressing to checking whether the image can be displayed on the second operating window, if the number of the dragged image files is singular.

5. The method according to claim 1, further comprising displaying the fetched image information.

6. The method according to claim 1, further comprising notifying that the image information can not be fetched, if the image can not be displayed on the second operating window.

7. The method according to claim 3, further comprising notifying that only one image file can be dragged if the number of the dragged image files is plural.

8. An image selecting apparatus comprising:
a checking unit which checks whether an image of an image file dragged from a first operating window to a second operating window can be displayed on the second operating window;
a dropping determining unit which drops the dragged image file to the second operating window in response to the checked result;
a file information acquiring unit which acquires file information of the dropped image file; and
an image information fetching unit which fetches image information of the image file using the acquired file information,
wherein the first operating window can display the image file, the second operating window is an operating window of a driver of an image forming apparatus, and the file information is information on a storage location of the image file.

9. The apparatus according to claim 8, further comprising a user interface unit which provides an interface including the first operating window and the second operating window which displays the fetched image information.

10. The apparatus according to claim 8, further comprising an image information changing unit which changes the fetched image information according to a user's instruction.

11. The apparatus according to claim 10, wherein the image information changing unit changes a size or a location of the fetched image displayed on the second operating window according to the user's instruction, and the fetched image is an image that the fetched image information represents.

12. The apparatus according to claim 10, further comprising a user interface unit which provides an interface including the second operating window for displaying the changed image information.

13. The apparatus according to claim 8, wherein the checking unit checks whether the number of the dragged image files is plural.

14. The apparatus according to claim 13, further comprising a user interface unit which notifies that only one image file can be dragged, in response to the result of checking whether the number of the dragged image files is plural.

15. The apparatus according to claim 13, wherein the drop determining unit drops the dragged image file to the second operating window, in response to the result of checking whether the image can be displayed on the second operating window and the result of checking whether the number of the dragged image files is plural.

16. A computer-readable medium having embodied thereon a computer program for an image selecting method comprising:
checking whether an image of an image file dragged from a first operating window to a second operating window can be displayed on the second operating window;
dropping the dragged image file to the second operating window, if the image can be displayed on the second operating window;
acquiring file information of the dropped image file; and
fetching image information of the image file using the acquired file information,
wherein the first operating window can display the image file, the second operating window is an operating window of a driver of an image forming apparatus, and the file information is information on a storage location of the image file.

17. A host device for enabling a user to select an image file having an image to be used as a watermark and to be printed at an image forming apparatus, comprising:
a user interface unit arranged to display a first operating window, a second operating window and setting information; and
a control unit configured to determine whether an image of an image file dragged from the first operating window to the second operating window can be displayed on the second operating window, drop the dragged image file to the second operating window, acquire file information of the dropped image file, and fetch image information of the image file using the acquired file information,
wherein the first operating window displays the image file, the second operating window is an operating window of a driver of the image forming apparatus, and the file information is information on a storage location of the image file.
